(19) United States
(12) Patent Application Publication
(10) Pub. No.: US 2003/0051230 A1
(43) Pub. Date: Mar. 13, 2003

(54) Code management software fast transactions using state table technology

(76) Inventors: Nikolay Molchanov, Fremont, CA (US); Anatoly Zvezdin, Novosibirsk (RU); Serguei N. Dmitriev, Novosibirsk (RU)

Correspondence Address: ROSENTHAL & OSHA L.L.P., 1221 MCKINNEY AVENUE, SUITE 2800, HOUSTON, TX, 77010, US

(21) Appl. No.: 09/951,206

(22) Filed: Sep. 13, 2001

(51) Int. Cl. G06F 9/44

(52) U.S. Cl. 717/120; 717/113

(57) ABSTRACT

A method of performing transactions in a code management software system. The method includes starting a transaction, determining existence of a state table for a workspace, creating the state table for the workspace if the state table does not exist, updating the state table for the workspace, and comparing a state table of a first workspace with a state table of a second workspace. A list of names of different files is created from the comparison of the state table of the first workspace and the state table of the second workspace. The list of names of different files is accessed during a match files phase. The state table is updated if the workspace is modified prior to an end of the transaction. The code management system is accessed using a graphical user interface.

### BACKGROUND OF INVENTION

One of the major challenges in developing large-scale, multi-platform software is coordinating the activities of a team of people, i.e., developers (typically, the creators of software), testers, technical writers, and managers. Often, the team of people is not at one location, but is dispersed between multiple locations. To improve productivity, communication, time-to-market, and quality of the software, the various phases of the development life cycle typically evolve concurrently, i.e., in parallel. Concurrent software development requires that the developers have access to a common software base for the purpose of developing and building the software. The main challenge with this type of development process is how to control access to the software base and track the changes made to the software base so that integrity of the software base is maintained. At any point in time, various configurations of the software base might exist because the various phases of the development cycle are evolving concurrently.

Most development teams use a Software Configuration Management (SCM) system to manage the software base. An SCM system, such as Concurrent Versions System (CVS), tracks the changes made to the files under the control of the control of the SCM system, and facilitates the merging of code. Sophisticated SCM systems, such as Rational® ClearCase® from Rational Software Corporation and Forte Code Management Software (CMS) from Sun Microsystems, Inc., provide other capabilities such as software building and process management (e.g., what changes can be made to the software base and who can make the changes).

SCM systems, such as Forte™ CMS (referred to as “CMS”), allow creation of one or more isolated workspaces. The term “workspace” refers to a directory and subdirectories included in the directory, and the files included in the directory and the subdirectories. Typically, the files are maintained under a version control system, such as Source Code Control System (SCCS) or Revision Control System (RCS). To use a CMS system for software management, the developers initially place the project directories and files (if available) in one high-level directory. The CMS system then transforms the high-level directory into a top-level (or parent) workspace. If project directories and files are not available, an empty parent workspace is created. After creating the parent workspace, the developers create the child workspaces with copies of the parent workspace files. The developers can then modify individual versions of the same file in their child workspaces without interfering with the work of other developers. After the files are modified in the child workspaces, the files are merged and copied to the parent workspace. Merging of files involves resolving conflicts between individual versions of the same file. During certain transactions the workspace is “locked out” (prevented from participating in transactions with other workspaces).

An example of a series of transactions involving the CMS system is shown in FIGS. 1A through 1E. Referring to FIG. 1A, a developer in workspace A (2) copies (4) the file from the parent workspace (6) into workspace A (2). A developer in workspace B concurrently copies (10) the file from the parent workspace (6) into workspace B (8). Referring to FIG. 1B, the developer in workspace B then modifies the file inside the workspace B (8) and transfers (12) the file back into the parent workspace (6). Now the changes made to the file by the developer in workspace B are available on the parent workspace (6). Referring to FIG. 1C, the developer in workspace A then modifies the file stored in workspace A (2) and attempts to transfer (14) the changed file back into the parent workspace (6). The CMS system blocks (16) the transfer of the modified file. As shown in FIG. 1D, the developer in workspace A then copies (18) the new version of the file (which includes the changes made by the developer in workspace B) from the parent workspace (6) into workspace A (2). Referring to FIG. 1E, after merging the two versions of the file, developer in workspace A is then able to transfer (20) the modified and merged file into the parent workstation (6).

Referring to FIG. 2, a block diagram of a traditional CMS system (70) system that allows transactions to be executed between a local workspace (72) and a remote workspace (74) is shown. The local workspace (72) is local in the sense that a CMS system client (76) uses local actions or a network file sharing protocol to access the contents of the local workspace (72). The remote workspace (74) is remote in the sense that the CMS system client (76) does not use local actions or a network file sharing protocol to access the contents of the remote workspace (74). In the figure, the remote workspace (74) is shown inside a repository (78). The CMS system (70) includes a CMS system server (80) that manages and provides access to the repository (78) and remote workspace (74). The CMS system client (76) communicates with the CMS system server (80) via an application programming interface (API). The CMS system client (76) executes the transaction logic locally and sends certain commands to the CMS system server (80) to be executed at the CMS system server (80). The result, such as the content of a file, an object, or an exception, is returned to the CMS system client (76).

A propagation engine provides the means to transfer changes in source code files between workspaces. FIG. 3 shows a block diagram of a traditional view of the propagation engine (100), which propagates changes between two local workspaces (102, 104). In the illustration, the workspace (104) is updated with the changes in the workspace (102). The operation of the propagation engine (100) is divided into three phases: a determine files phase (106), a match files phase (108), and a propagate phase (110).

When a transaction begins (indicated at 112), the determine files phase (106) calls a program or script (114) that generates a list of files (113) (e.g., a file object) in the workspace (102). The program or script (114) is referred to as a file list program (FLP). The FLP (114) opens a given directory representing the workspace (102) and outputs the content of the directory, i.e., the files and subdirectories, to the propagation engine (100). The propagation engine (100) monitors the output of the FLP (114). Once there is data at the output of the FLP (114), an Add File function (115) is called to read the output of the FLP (114). If the name read from the output of the FLP (114) is a file, the Add File function (115) obtains information about the file. If the name read from the output of the FLP (114) is a directory, the Add File function (115) calls the FLP (114) on the directory. The Add Files function (115) continues to call the FLP (114) until information about all the files in the workspace (102) has been retrieved.

For every filename read from the output of the FLP (114), the Add File function (115) creates a file object and fills the fields of the file object with information about the file. For example, suppose that a filename “File A” is read from the output of the FLP (114). The Add File function (115) uses normal file input/output operations to determine whether “File A” exists in both workspaces (102, 104). If “File A” exists in both workspaces (102, 104), a field in the file object is filled with data which indicates that “File A” exists in both workspaces (102, 104).

The determine files phase (106) also calls an FLP (118) to generate a list of files in the workspace (104). The Add File Function (115) is invoked as previously described to create file objects and obtain information about the files in the workspace (104).

The match files phase (108) detects renames in both workspaces (102, 104). The match files phase (108) works with the file objects created in the determine files phase (106) as well as name tables in the workspaces (102, 104). The match file phase (108) opens files in both workspaces in order to get name histories. The propagate files phase (110) goes through the list of file objects and performs appropriate actions for each file according to the propagation state of the file.

The propagate files phase (110) also reads the files in both workspaces (102, 104), merges their histories and bodies, and then writes the merged results into the workspace (104). It should be noted that the match files phase and the propagate files phase assume that the workspace files are stored under a version control system, such as SCCS (“Source Code Control System”) or RCS (“Revision Control System”). Upon completion of the propagate files phase (110), the transaction ends (116).

As can be observed from FIG. 3, there are many file input/output operations, i.e., read, write, and stat, performed on both sides during the transaction which are not suitable for a remote client/server (or client/repository) model. Preferably, in a remote client/server model, the propagation engine (100) would not use file input/output operations directly. Instead, the propagation engine (100) would use some protocol or application programming interfaces (API's) provided by the repository in order to work with the workspace files.

### SUMMARY OF INVENTION

In general, in one aspect, the invention comprises a method of performing transactions in a code management software. The method comprises starting a transaction, determining existence of a state table for a workspace. If the state table does not exist, the state table for the workspace is created. The state table for the workspace is updated. A state table of a first workspace is compared with a state table of a second workspace. A list of names of different files is created from the comparison of the state table of the first workspace and the state table of the second workspace. The list of names of different files is accessed during a match files phase. The state table is updated if the workspace is modified prior to an end of the transaction. The code management system is accessed using a graphical user interface.

In general, in one aspect, the invention comprises a state table for use with a code management software system. The state table comprises a plurality of rows and columns. The rows are associated with a file entry derived from an s-file in a workspace. The columns are associated with a property of the file entry. The file entry of a state table of a first workspace is compared to the file entry of a state table of a second workspace to create a list of names of different files used by the code management software system.

In general, in one aspect, the invention comprises a method of updating a state table. The method comprises searching for an s-file in a workspace and comparing the s-file found in the workspace to an associated file entry of the state table. The associated file entry of the state table is removed if no matching s-file exists in the workspace. A new file entry in the state table is created if the s-file found in the workspace has no associated file entry in the state table. A checksum value of the s-file calculated and the value of a property associated with the file entry is updated if the value of the property of the s-file and the associated file entry are not equal.

In general, in one aspect, the invention comprises a method of comparing state tables during a transaction. The method comprises selecting a file entry of a first state table, selecting a file entry of a second state table, comparing a value of a property of the file entry of the first state table with a value of a property of the file entry of the second state table. The file name property of the file entry of the first state table is entered into the list of names of different files if no matching property value is found in the file entry of the second state table. The file name property of the file entry of the second state table is entered into the list of names of different files if no matching property value is found in the file entry of the first state table.

In general, in one aspect, the invention comprises a list of names of different files. The list of names of different files comprises a file name property value and a file list of the file name property value generated by comparing a value of a property of a file entry of a first state table to a value of a property of a file entry of a second state table.

In general, in one aspect, the invention comprises a computer system to perform transactions in a code management software system. The computer system comprises a processor, a memory, a computer display. Software instructions stored in the memory enable the computer system, under control of the processor, to perform: starting a transaction, determining existence of a state table for a workspace, creating the state table for the workspace, updating the state table for the workspace, comparing a state table of a first workspace with a state table of a second workspace, and creating a list of names of different files from the comparison of the state table of the first workspace and the state table of the second workspace.

In general, in one aspect, the invention comprises an apparatus to perform fast transactions in a code management software system. The apparatus comprises means for starting a transaction, means for determining existence of a state table for a workspace, means for creating the state table for the workspace, means for updating the state table for the workspace, means for comparing a state table of a first workspace with a state table of a second workspace, and means for creating a list of names of different files from the comparison of the state table of the first workspace and the state table of the second workspace.

In general, in one aspect, the invention comprises an apparatus to update a state table. The apparatus comprises means for searching for an s-file in a workspace, means for comparing the s-file found in the workspace to an associated file entry of the state table, means for removing the associated file entry of the state table if no matching s-file exists in the workspace, means for creating a new file entry in the state table if the s-file found in the workspace has no associated file entry in the state table, and means for calculating a checksum value of the s-file and updating the value of a property associated with the file entry if the value of the property of the s-file and the associated file entry are not equal.

In general, in one aspect, the invention comprises an apparatus to compare state tables during a transaction. The apparatus comprises means for selecting a file entry of a first state table, means for selecting a file entry of a second state table, means for comparing a value of a property of the file entry of the first state table with a value of a property of a file entry of a second state table, means for entering the file name property of the file entry of the first state table into the list of names of different files if no matching property value is found in the file entry of the second state table, and means for entering the file name property of the file entry of the second state table into the list of names of different files if no matching property value is found in the file entry of the first state table.

Other aspects and advantages of the invention will be apparent from the following description and the appended claims.

### BRIEF DESCRIPTION OF DRAWINGS

FIGS. 1A through 1E represent a typical series of transactions that occur in an SCM system.

FIG. 2 shows a block diagram of a CMS system allowing remote transactions to be executed between a local workspace and a remote workspace.

FIG. 3 system shows a block diagram of a propagation engine that transfers files between two workspaces locally

FIG. 4 shows a block diagram of a typical computer.

FIG. 5 shows a flowchart of a CMS system fast transaction using state table technology in accordance with one or more embodiments of the present transaction.

FIG. 6 is a tabular representation of a state table in accordance with one or more embodiments of the present invention.

FIG. 7 illustrates a method for updating the contents of a state table in accordance with one or more embodiments of the present invention.

FIG. 8 illustrates a method of comparing state tables of two workspaces in accordance with one or more embodiments of the present invention.

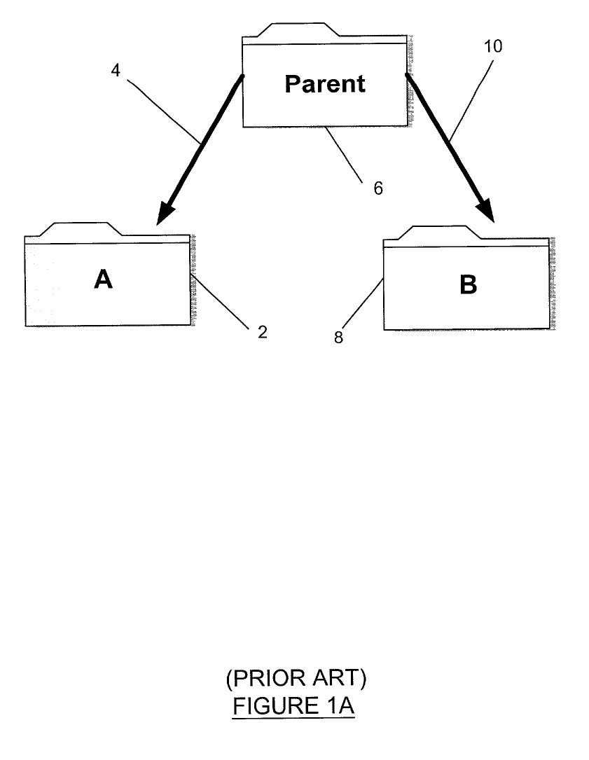

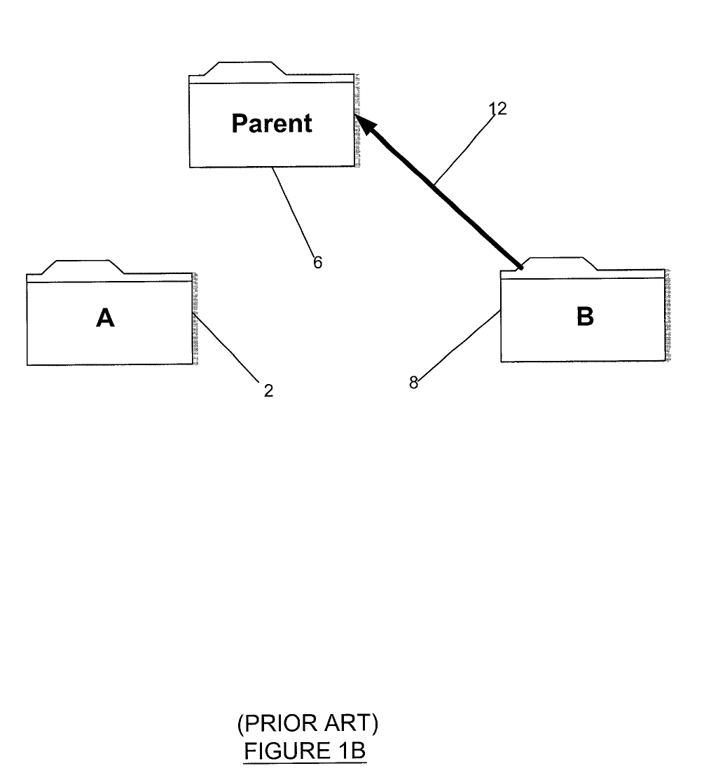

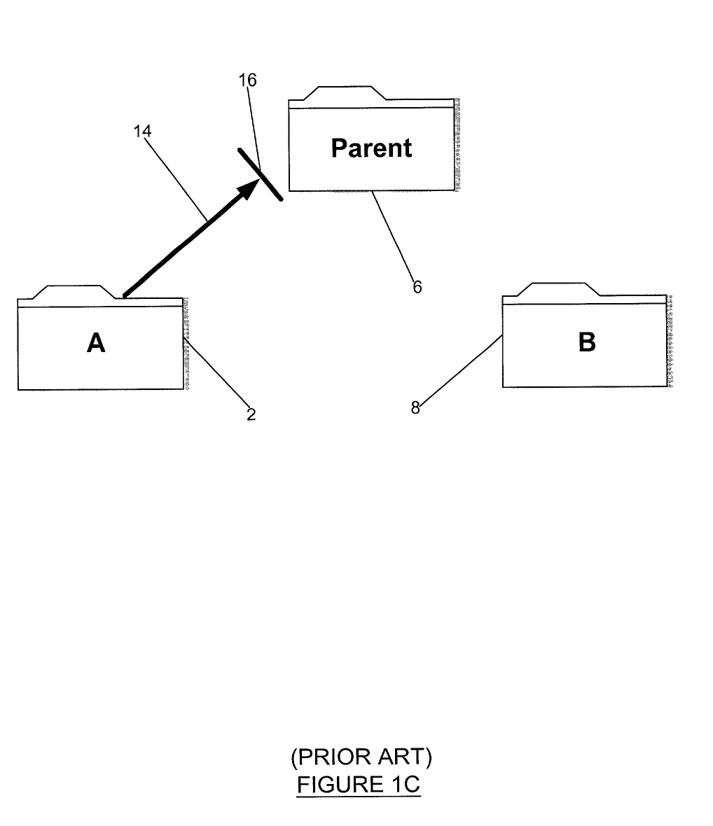

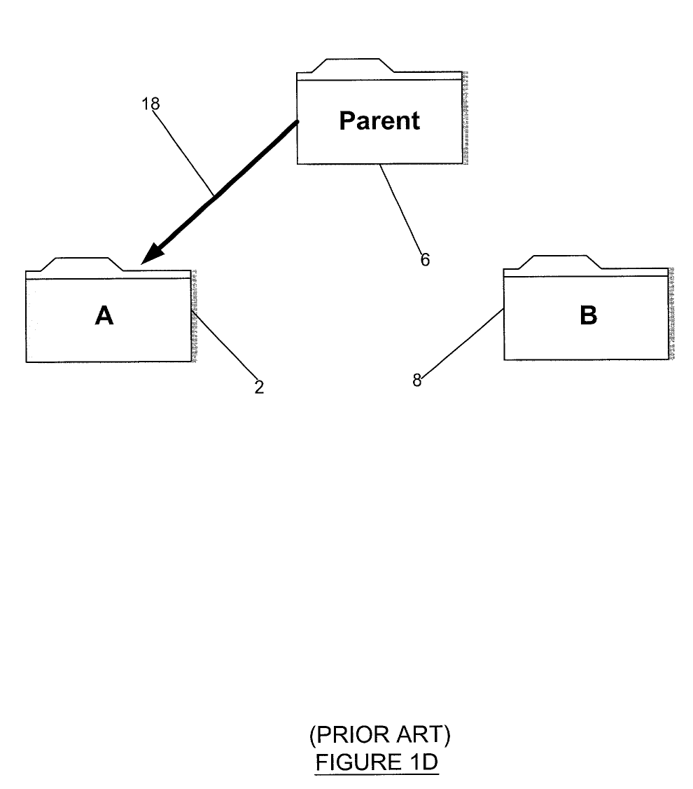

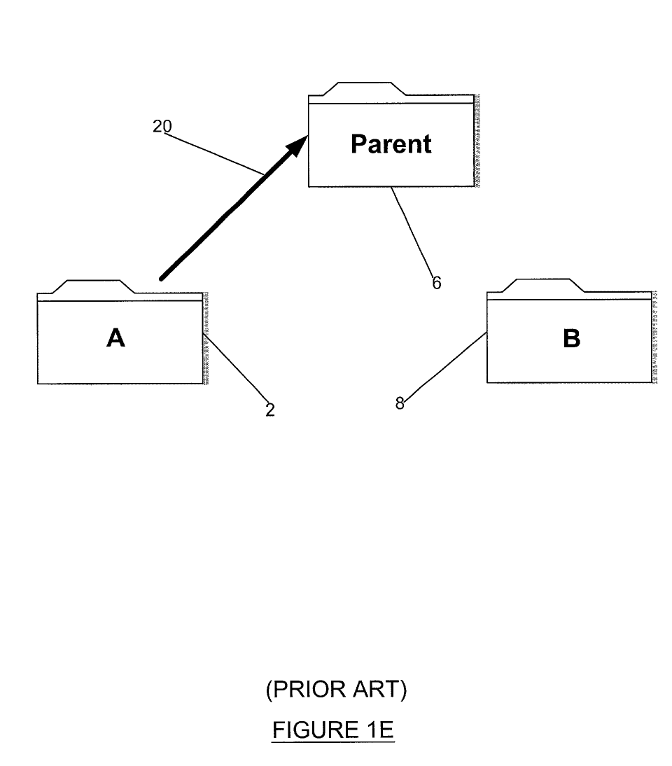

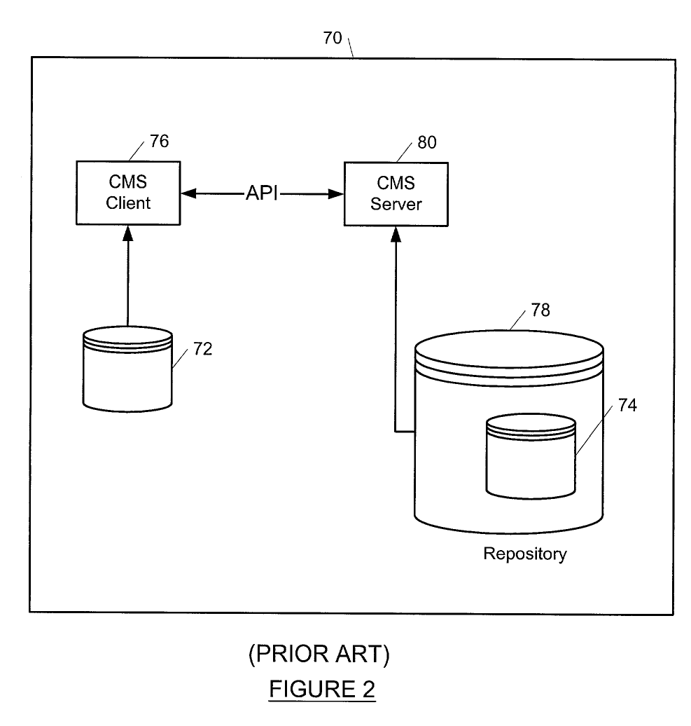

### DETAILED DESCRIPTION

In the following detailed description of the invention, numerous specific details are set forth in order to provide a more thorough understanding of the invention. However, it will be apparent to one of ordinary skill in the art that the invention may be practiced without these specific details. Well-known features are not described in detail here.

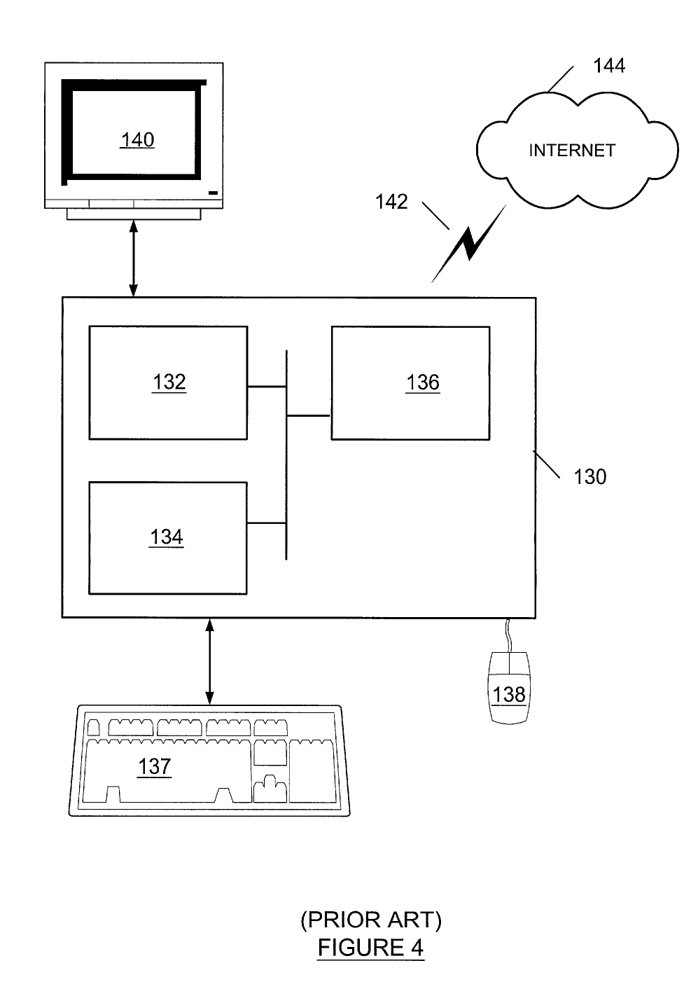

The present invention may be implemented on virtually any type computer regardless of the platform being used. For example, as shown in FIG. 4, a typical computer (130) includes a processor (132), an associated memory (134), a storage device (136), and numerous other elements and functionalities typical of today's computers (not shown). The computer (130) may also include input means, such as a keyboard (137) and a mouse (138), and an output device, such as a monitor (140). Those skilled in the art appreciate that these input and output means may take other forms in an accessible environment. The computer (130) is connected via a network connection (142) to a network, such as the Internet (144), etc.

Information stored in files included in the CMS system or in the workspace at any given time represents in part or in whole the state of the software system (the word “state,” as used here, is synonymous with “condition”). The state of the workspace is represented by the information stored in the files in the workspace. Each file is described by certain properties associated with the file (e.g., file type, file size, file name, the date and time the file was last modified, result of checksum calculations, etc.). The file type property may include values, such as check-in, check-out, etc. A checksum calculation is performed upon a file to obtain a numerical value based upon the content of the information stored in the file. If the content of the file is altered in some way, the checksum calculation performed before the alteration gives a different result than the checksum calculation performed after the alteration.

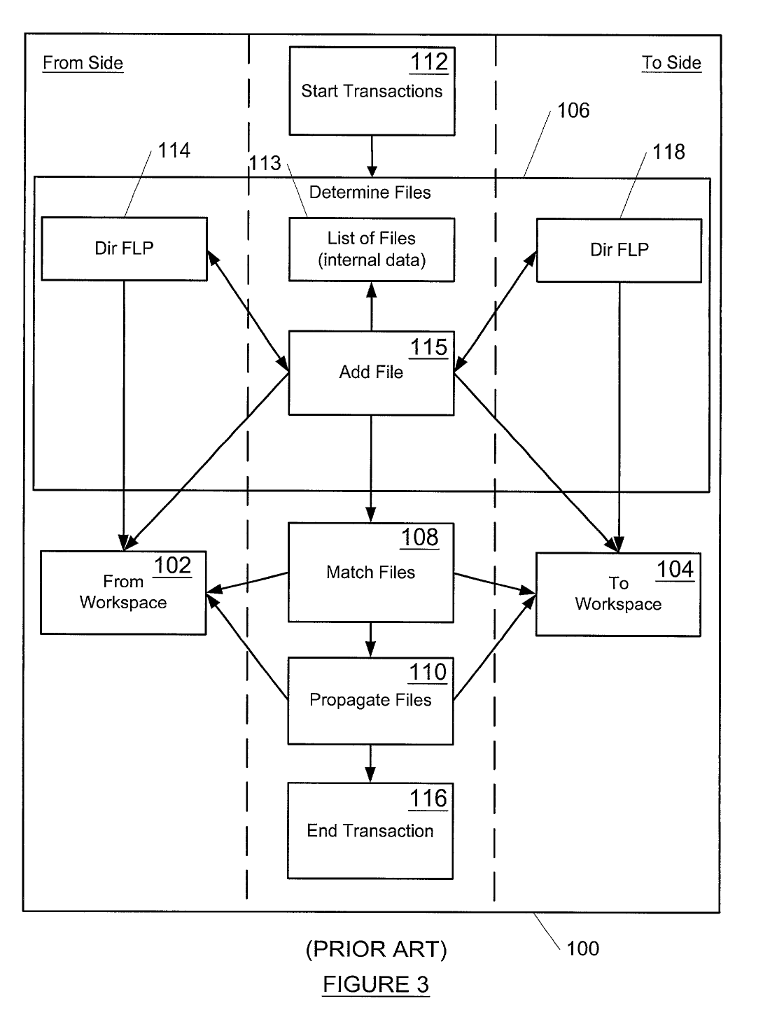

As mentioned above, the propagation engine as shown in FIG. 3 is divided into three phases: a determination files phase (106), a match files phase (108), and a propagate phase (110). The present invention involves a modification of the determine files phase (106). The determine files phase is modified by the introduction of state tables and the creation of a list of names of different files.

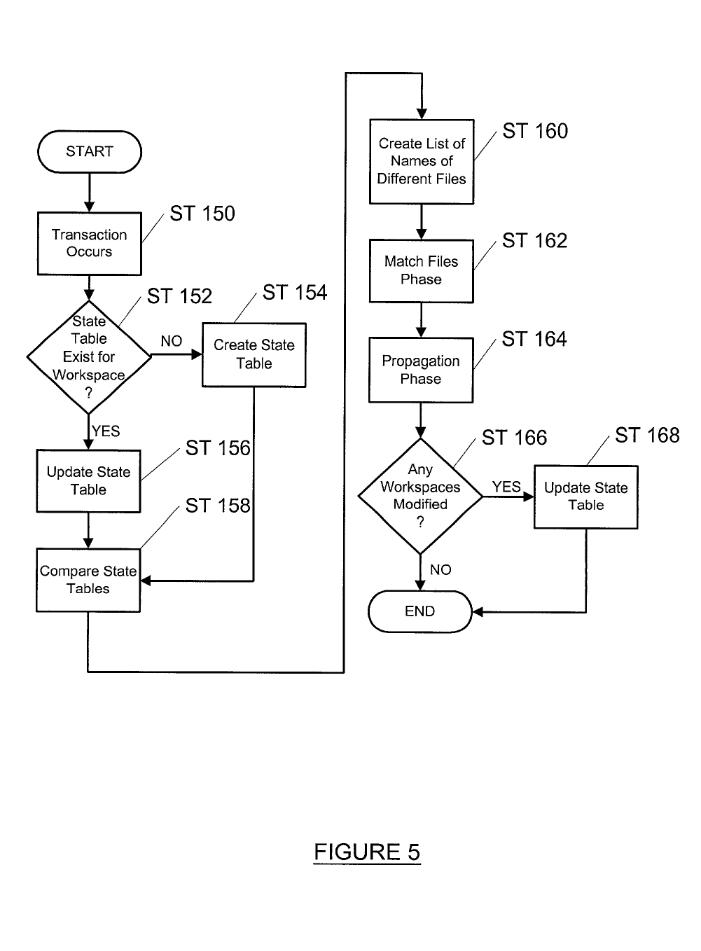

In order to optimize the performance of transactions, a state table is associated with each workspace. Referring to FIG. 5, when a transaction occurs (Step 150), if the state table does not exist for the workspace (Step 152), the state table is created (Step 154). If the state table already exists for the workspace, the state table is updated (Step 156). Next, the state tables for the workspaces are compared (Step 158). Based on the comparison, a list of names of different files is created (Step 160). Following this step, the match files (Step 162) and the propagation phase (Step 164) are performed. In one or more embodiments of the present invention, prior to the end of the transaction, a determination is made as to whether or not any workspaces are modified (Step 166). If a workspace is modified, the state table associated with the workspace is updated (Step 168). Otherwise, the transaction ends.

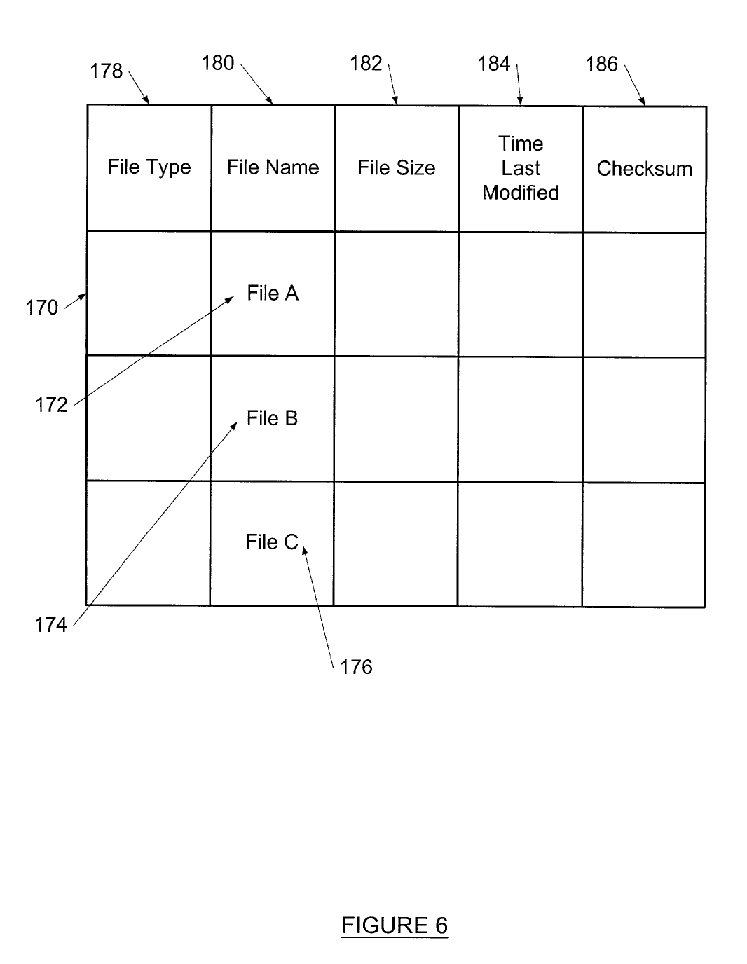

An exemplary state table shown in FIG. 6 is represented in tabular form. A row (170) of the state table is associated with a file in the workspace, and a column is associated with a certain property of the file. The workspace associated with the state table represented by FIG. 6 includes a file named “file A” (172), a file named “file B” (174), and a file named “file C” (176). The state table has several columns, which are associated with and store the values of several properties, including a file type property (178), a file name property (180), a file size property (182), a time-last-modified property (the time the file was last modified) (184), and a file checksum property (186). The state table has several rows, which are associated with files in a workspace, e.g., file A, file B, file C, etc. One skilled in the art can appreciate that the number of columns, rows, and files may be greater or fewer in number and may be referenced by different names.

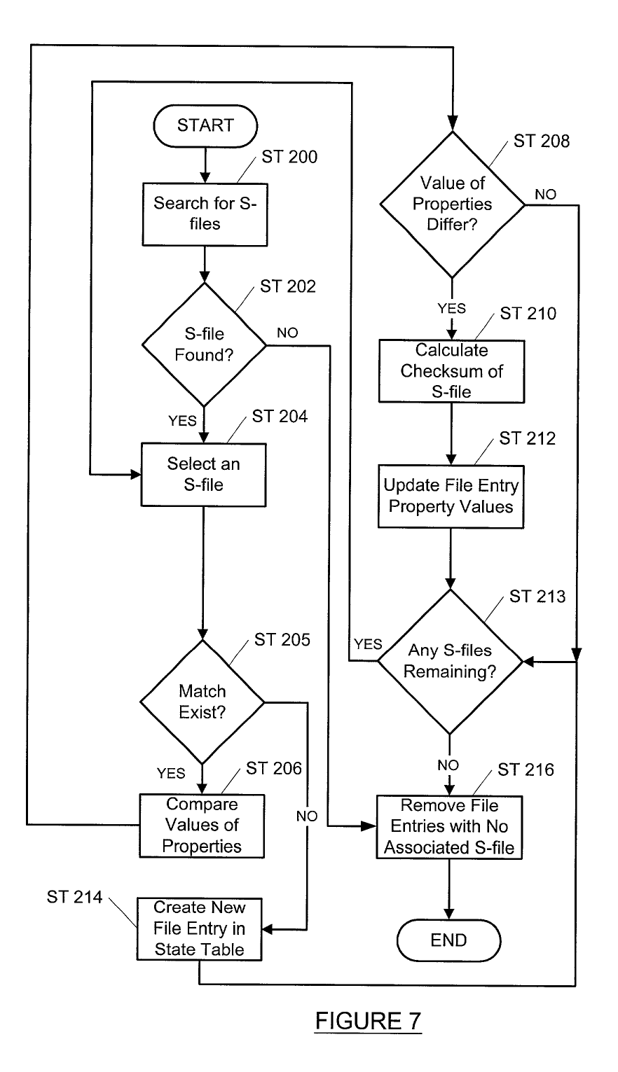

In one or more embodiments of the present invention, the process of updating the contents of a state table for a workspace may be implemented as shown in FIG. 7. First, a search is initiated in the workspace for files incorporating source code (referred to as an “s-file” herein) (Step 200). For each s-file found in the workspace (Step 202), the s-file is selected (Step 204). Next, a determination is made as to whether a match between the s-file and an associated file entry in the state table exists (Step 205). The values of the file type, the file name, the file size, the time-last-modified of the s-file are compared to the values of the properties of the associated file entry in the state table (if such an associated file entry exists) (Step 206). If the values of the properties of the s-file differ from the values of the properties of the associated file entry (Step 208), a checksum value for the s-file is calculated (Step 210), and the associated file entry is updated to reflect the changed property values (Step 212), including the value of the file checksum property of the s-file. After updating the associated file entry, a determination is made as to whether any s-files remain in the workspace (Step 213). If s-files remain in the workspace, another s-file is selected (Step 204) and the process continues. If an s-file exists for which there is no associated file entry in the state table, i.e., new, then a new file entry in the state table is created (Step 214). If a file entry exists in the state table for which no associated s-file exists in the workspace, the file entry is removed from the state table (Step 216).

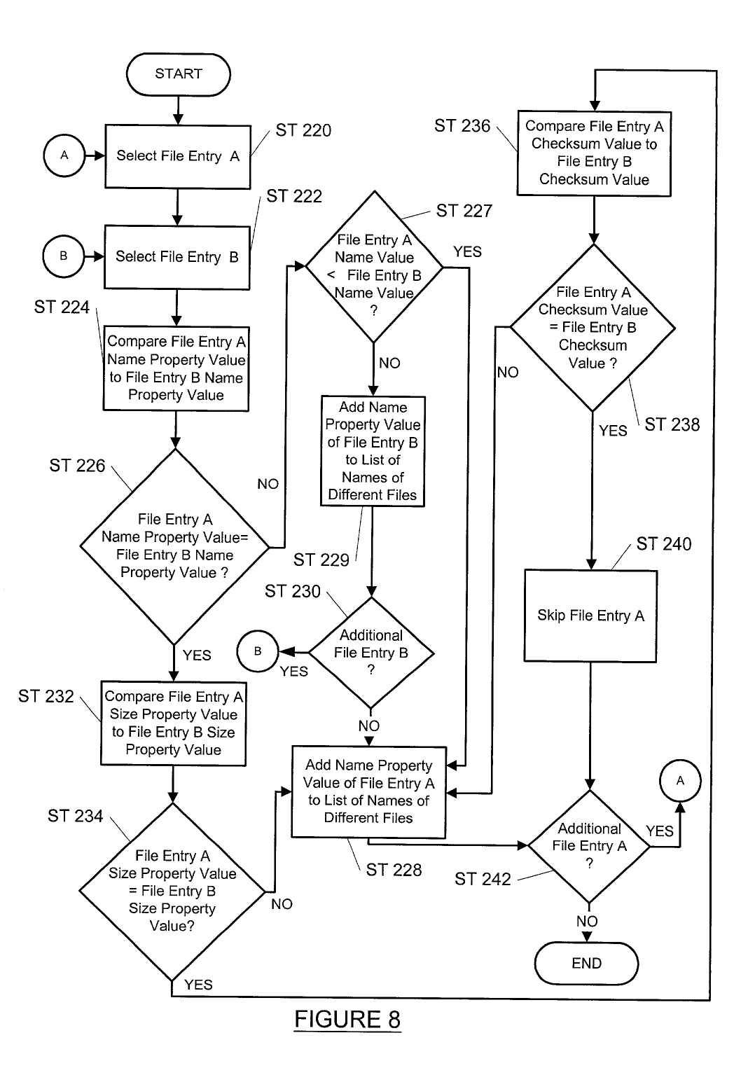

In one or more embodiments of the present invention, FIG. 8 represents a process of comparing state tables of two workspaces. The states tables of the workspaces are sorted alphabetically. The result of the comparison is a generated list of names of different files to be used during a transaction between two workspaces. A file entry in the state table of workspace A (hereinafter, “File Entry A”) is selected (Step 220). A file entry in the state table of workspace B (hereinafter, “File Entry B”) is selected (Step 222). The value of a file name property of File Entry A is compared to the value of a file name property of File Entry B (Step 224).

A determination is made as to whether the file name property of File Entry A is the same as the file name property of File Entry B (Step 226). If the value of the file name property of File Entry B is not equal to the value of the file name property of File Entry A, then a determination is made as whether the value of the file name property of File Entry A is less than the value of the file name property of File Entry B (Step 227). If the value of the file name property of File Entry A is less than the value of the file name property of File Entry B. then the value of the file name property of File Entry A is added to the list of names of different files (Step 228). Otherwise, if the value of the file name property of File Entry A is greater than the value of the file name property of File Entry B, then the value of the file name property of File Entry B is added to the list of names of different files (Step 229). Then a determination is made as to whether one or more additional File Entry B exist (Step 230). If another File Entry B exists, then another File Entry B is selected (Step 222) and the process begins anew. Otherwise, if no additional File Entry B exists, the value of the file name property of File Entry A is added to the list of names of different files (Step 228). If additional File Entry A exist (Step 242), then another File Entry A is selected (Step 220) and the process begins anew.

If the value of the file name property of File Entry A is found to be the same as the value of the file name property of File Entry B, then the value of the file size property of File Entry A and the value of the file size property of File Entry B are compared (Step 232). A determination is made as to whether the value of the file size property of File Entry A is equal to the value of the file size property of File Entry B (Step 234). If the value of the file size property of File Entry A is not equal to value of the file size property of File Entry B, then the value of the file name property of File Entry A is added to the list of names of different files (Step 228). If additional File Entry A exist (Step 242), then another File Entry A is selected (Step 220) and the process begins anew.

If the value of the file size property of File Entry A is equal to the value of the file size property of File Entry B, then the value of the file checksum property of File Entry A is compared to the value of the file checksum property of File Entry B (Step 236). A determination is made as to whether the value of the file checksum property of File Entry A is equal to the value of the file checksum property of File Entry B (Step 238). If the value of the file checksum property of File Entry A is not equal to the value of the file checksum property of File Entry B, the value of the file name property of File Entry A is added to the list of names of different files (Step 228).

If the value of the file checksum property of File Entry A is equal to the value of the file checksum property of File Entry B, then File Entry A is skipped and the value of the file name property of File Entry A is not added to the list of names of different files (Step 240). If additional File Entry A exist (Step 242), then another File Entry A is selected (Step 220) and the process begins anew.

The foregoing method for generating the list of names of different files may involve other file entries in different state tables of workspaces involved in a transaction. Also, the name and order of the file entry of the state table may vary. Those skilled in the art can appreciate that the events discussed in this paragraph, in one or more different implementations of the invention, may be fewer or greater in number, or may occur in a different sequence, than as shown above.

The list of names of different files generated by this aforementioned process is accessed by various phases, operations, functions, etc., within the CMS system involving the management of workspaces. Referring back to FIG. 3, the list of names of different files is accessed primarily from the match files phase (108) to detect renames in both workspaces and to get name histories of the files.

Advantages of the present invention may include one or more of the following. State table technology improves transaction performance for local workspaces by, for example, optimizing the list of files involved in the transaction, optimizing the number of file and file system accesses, optimizing the time the workstation spends in the locked condition, optimizing the effect of a slow network connection, optimizing network traffic, and/or optimizing the process of updating information to computer user interfaces (e.g., graphical user interfaces, etc.). State table technology improves transaction performance for workspaces residing on remote servers by, for example, verifying the correctness of received data, optimizing the number of files, optimizing the list of files involved in the transaction, continuing transactions between two workspaces after the communications link between the two workspaces has been broken and then restored, optimizing the effect of a slow network connection, optimizing network traffic, and optimizing the process of updating information to computer user interfaces (e.g., graphical user interfaces, etc.). Those skilled in the art can appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of performing transactions in a code management software system, comprising:
starting a transaction;
determining existence of a state table for a workspace;
creating the state table for the workspace if the state table does not exist;
updating the state table for the workspace;
comparing a state table of a first workspace with a state table of a second workspace; and
creating a list of names of different files from the comparison of the state table of the first workspace and the state table of the second workspace.

2. The method of claim 1, further comprising:
accessing the list of names of different files during a match files phase.

3. The method of claim 1, further comprising:
updating the state table if the workspace is modified prior to an end of the transaction.

4. The method of claim 1, further comprising:
accessing the code management system using a graphical user interface.

5. The method of claim 1, wherein the workspace is remote.

6. The method of claim 1, wherein the workspace is local.

7. The method of claim 1, wherein the workspace is stored in a repository.

8. A method of performing transactions in a code management software system, comprising:
starting a transaction;
determining existence of a state table for a workspace;
creating the state table for the workspace if the state table does not exist;
updating the state table for the workspace;
comparing a state table of a first workspace with a state table of a second workspace;
creating a list of names of different files from the comparison of the state table of the first workspace and the state table of the second workspace;
accessing the list of names of different files during a match files phase;
updating the state table if the workspace is modified prior to an end of the transaction; and
accessing the code management system using a graphical user interface.

9. A state table for use with a code management software system, comprising:
a plurality of rows and columns;
the rows associated with a file entry derived from an s-file in a workspace; and
the columns associated with a property of the file entry;
wherein, the file entry of a state table of a first workspace is compared to the file entry of a state table of a second workspace to create a list of names of different files used by the code management software system.

10. The state table of claim 9, wherein the state table comprises information stored as a plurality of file entries described by properties.

11. The state table of claim 9, wherein the property of the file entry comprises a file type, a file name, a file size, a last modified time, and a file checksum of the s-file.

12. The state table of claim 9, wherein the workspace is remote.

13. The state table of claim 9, wherein the workspace is local.

14. The state table of claim 9, wherein the workspace is stored in a repository.

15. A method of updating a state table, comprising:
searching for an s-file in a workspace;
comparing the s-file found in the workspace to an associated file entry of the state table;
removing the associated file entry of the state table if no matching s-file exists in the workspace;
creating a new file entry in the state table if the s-file found in the workspace has no associated file entry in the state table; and
calculating a checksum value of the s-file and updating the value of a property associated with the file entry if the value of the property of the s-file and the associated file entry are not equal.

16. The method of claim 15, wherein the property comprises a file type, a file name, a file size, and a last modified time.

17. The method of claim 15, wherein the workspace is remote.

18. The method of claim 15, wherein the workspace is local.

19. The method of claim 15, wherein the workspace is stored in a repository.

20. A method of comparing state tables during a transaction, comprising:
selecting a file entry of a first state table;
selecting a file entry of a second state table;
comparing a value of a property of the file entry of the first state table with a value of a property of the file entry of the second state table;
entering the file name property of the file entry of the first state table into the list of names of different files if no matching property value is found in the file entry of the second state table; and
entering the file name property of the file entry of the second state table into the list of names of different files if no matching property value is found in the file entry of the first state table.

21. The method of claim 20, further comprising:
skipping the file entry of the first state table if all property values of the file entry of the second state table match the property values of the file entry of the first state table.

22. The method of claim 20, wherein the property comprises a file name, a file size, and a file checksum.

23. A list of names of different files, comprising:
a file name property value; and
a file list of the file name property value generated by comparing a value of a property of a file entry of a first state table to a value of a property of a file entry of a second state table.

24. The list of names of different files of claim 23, wherein the property comprises a file name a file size, and a file checksum.

25. The list of names of different files of claim 23, wherein the file list is accessed by a match files phase.

26. A computer system to perform transactions in a code management software system, comprising:
a processor;
a memory;
a computer display; and
software instructions stored in the memory for enabling the computer system under control of the processor, to perform:
starting a transaction;
determining existence of a state table for a workspace;
creating the state table for the workspace;
updating the state table for the workspace;
comparing a state table of a first workspace with a state table of a second workspace; and
creating a list of names of different files from the comparison of the state table of the first workspace and the state table of the second workspace.

27. The system of claim 26, wherein the workspace is remote.

28. The system of claim 26, wherein the workspace is local.

29. The system of claim 26, wherein the workspace is stored in a repository.

30. An apparatus to perform fast transactions in a code management software system, comprising:
means for starting a transaction;
means for determining existence of a state table for a workspace;
means for creating the state table for the workspace;
means for updating the state table for the workspace;
means for comparing a state table of a first workspace with a state table of a second workspace; and
means for creating a list of names of different files from the comparison of the state table of the first workspace and the state table of the second workspace.

31. An apparatus to update a state table, comprising:
means for searching for an s-file in a workspace;
means for comparing the s-file found in the workspace to an associated file entry of the state table;
means for removing the associated file entry of the state table if no matching s-file exists in the workspace;
means for creating a new file entry in the state table if the s-file found in the workspace has no associated file entry in the state table; and
means for calculating a checksum value of the s-file and updating the value of a property associated with the file entry if the value of the property of the s-file and the associated file entry are not equal.

32. An apparatus to compare state tables during a transaction, comprising:
means for selecting a file entry of a first state table;
means for selecting a file entry of a second state table;
means for comparing a value of a property of the file entry of the first state table with a value of a property of a file entry of a second state table;
means for entering the file name property of the file entry of the first state table into the list of names of different files if no matching property value is found in the file entry of the second state table; and
means for entering the file name property of the file entry of the second state table into the list of names of different files if no matching property value is found in the file entry of the first state table.
